(19) United States
(12) Patent Application Publication
(10) Pub. No.: US 2008/0071596 A1
(43) Pub. Date: Mar. 20, 2008

(54) NATURAL GAS-BASED DISTRIBUTION SYSTEM AND METHOD

(76) Inventor: David Randolph Smith, Kilgore, TX (US)

Correspondence Address: FULBRIGHT & JAWORSKI, LLP, 1301 MCKINNEY, SUITE 5100, HOUSTON, TX, 77010-3095, US

(21) Appl. No.: 11/462,447

(22) Filed: Aug. 4, 2006

(51) Int. Cl. G05B 19/418; G06Q 10/00; G06Q 30/00; G06F 9/46

(52) U.S. Cl. 705/8; 705/35; 705/1

(57) ABSTRACT

A product distribution method and system using LNG fuel and refrigerant is described. The method and system combines the production, storing, transporting, and consuming of liquid natural gas as a transportation fuel and refrigerant fluid.

### TECHNICAL FIELD

This invention pertains to distribution systems and methods for natural gas and goods.

### BACKGROUND OF THE INVENTION

The economy of the industrialized world depends on the distribution of products from one point in a distribution network to another. Additionally, significant portion of the products to be distributed and stored are moved by vehicles that are fueled by diesel, gasoline, propane, or other crude oil derivative products. It is estimated that over 60% of the world's crude oil production is converted into transport fuels, and over 90% of all products at one point in a distribution network are transported on vehicles that use crude oil derivatives. In order to not use crude oil derivate products, which are increasing difficult to find, are becoming higher in demand as the world usage increases, and continually threatened by geopolitical issues, it is clear that what is need are distribution systems and methods that use fuels other than crude oil derivates.

The need to replace, or at least supplement, crude oil derivative products as fuel sources has been long recognized. Natural gas is a desirable alternative. Natural gas can be compressed and liquefied to make liquefied natural gas (LNG). Such a distribution system should not be dependent on crude oil derivative products, yielding a viable and environmentally superior distribution system.

### BRIEF SUMMARY OF THE INVENTION

The present invention encompasses a system and method for the distribution of natural gas and goods.

In one embodiment, there is a system for the distribution of goods and/or natural gas, said system comprising: at least one source of natural gas; optionally, at least one LNG plant coupled to the source; at least one natural gas storage facility, the at least one storage facility coupled to the at least one source, the at least one LNG plant, or to any combination thereof; a plurality of over the road vehicles powered by natural gas, the plurality of vehicles coupled to the at least one source of natural gas, to the at least one LNG plant, to the at least one natural gas storage facility, or to any combination thereof; at least one retail facility, the at least one retail facility being a retail facility where products are sold and bought including natural gas, the at least one retail facility coupled to the at least one source, to said at least one LNG plant, to at least one of said plurality of over the road vehicles, or to any combination thereof; and, at least one warehouse facility, the at least one warehouse facility being cooled or heated by natural gas, the at least one warehouse facility coupled to the at least one source, to the at least one LNG plant, to at least one of the plurality of over the road vehicles, or to any combination thereof. In some embodiments, the source is a natural gas pipeline. In some embodiments, the source is an LNG pipeline coupled to an LNG transport ship via an LNG terminal at a port. In some embodiments, the source is an LNG storage tank. In some embodiments, the source is an LNG transport trailer. In some embodiments, the source is an LNG manufacturing facility overseas. In some embodiments, the source comprises a natural gas well. Preferably, the system fiber comprises a network of distributed liquid natural gas plants. Preferably, one or more of the plurality of over the road vehicles are cooled and/or heated by natural gas. The system preferably further comprises one or more electrical generators powered by natural gas. In some of such embodiments, the generators are preferably coupled to an electrical transmission and/or distribution network. In some embodiments, at least one LNG storage tank is located at a retail sales location. In some embodiments, the plurality of over the road vehicles comprises at least one tractor-trailer, wherein the tractor-trailer has a prime mover that is powered by natural gas and further wherein the tractor-trailer is cooled and/or heated by natural gas.

In another aspect of the present invention, there is a method of distributing goods and/or natural gas, the method comprising the step of: coupling at least one source of natural gas with optionally, at least one LNG plant coupled to the source; at least one natural gas storage facility; a plurality of over the road vehicles powered by natural gas; and, at least one warehouse facility, optionally the at least one warehouse facility being cooled and/or heated by natural gas. In some embodiments, the step of coupling at least one source comprises coupling with a natural gas pipeline. In some embodiments, the step of coupling at least one source comprises coupling with a pipeline from a LNG transport ship. In some embodiments, the step of coupling at least one source further comprises coupling with an LNG storage tank. In some embodiments, the step of coupling at least one source further comprises coupling with an LNG manufacturing facility over seas from the distribution network. In some embodiments, the step of coupling at least one source further comprises coupling with a network of distributed liquid natural gas plants. In some embodiments, one or more of the plurality of over the road vehicles are cooled and/or heated by natural gas. In some of such embodiments, the cooled or heated vehicles are cooled or heated by power from a natural gas fueled fuel cell. In some embodiments, the step of coupling at least one source further comprises coupling with one or more electrical generators powered by natural gas. In some embodiments, the electrical generators comprise fuel cells powered by natural gas. In some embodiments, the generators are coupled to an electrical transmission and/or distribution network. In some embodiments, at least one of the LNG storage tanks is located at a retail sales location. In some embodiments, the method further comprises the step of pumping LNG as a liquid and heating said LNG to form a gas for compressed natural gas fuel applications. In some of such embodiments, the natural gas fuel applications are selected from the group consisting of fuel cells, internal combustion engine, healing, cooking, and any combination thereof. In some embodiments, the plurality of over the road vehicles comprises at least one tractor-trailer, wherein the tractor-trailer has a prime mover that is powered by natural gas. In some embodiments, the plurality of over the road vehicles comprises at least one prime mover powered by a natural gas internal combustion engine. In some embodiments, the plurality of over the road vehicles contains at least one fuel cell vehicle fueled with natural gas.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 provides an illustrative example of the distribution network providing illustrative examples of some of the elements of the natural gas network of the instant invention.

### DETAILED DESCRIPTION OF THE INVENTION

As used herein, the word “a” or “an”, when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

As used herein, the term “natural gas” is defined as the term is understood by those of ordinary skill in the art with the proviso that the term covers all phases, including both gas and liquid. Thus, LNG is one form of natural gas. Compressed natural gas (CNG) is also another form of natural gas, specifically a form of gaseous natural gas.

The cryogenic region is that region of temperatures below under about −65° C. All gases, including natural gas (methane) can be liquefied at extremely low temperatures. Such liquid gases are commonly called “cryogenic fluids”. Once liquefied, Such gases, when liquefied, will remain in a liquid phase even at atmospheric pressure, provided that it is kept at its saturation temperature.

Basic concepts in the liquefaction techniques are isoenthalpic and isoentropic phenomena. In the case of using isenthalpic expansion (Joule-Thompson effect), the decrease in the fluid temperature is provided by the pressure drop through the valve. The cooling which is the result of expansion or throttling of a gas from a high to low pressure is called Joule Thompson cooling. A gaseous pure substance has a positive Joule-Thompson coefficient could go through a continuous temperature decrease and finally it becomes liquefied by using throttling processes. A positive Joule-Thompson coefficient indicates that the temperature drops during such a throttling process, indicative of a good refrigerant. Natural gas is a good refrigerant.

An isentropic process can also be used. In this thermodynamic scenario, a turbo-expander is used to effect a pressure drop. In this case work is done to the turbine and the gases expand and cool. The saturation temperature of natural gas is −163° C. Fuel volume increases approximately 600 times when LNG becomes gas. This reduction in volume provides significant economic advantages in storing and transporting of natural gas. LNG boils at −163° C. and vaporizes rapidly when exposed to higher temperatures. The gas itself is much lighter than air and therefore rises from spills. Since at this time the LNG and its vapor is not odorized, it is completely odorless and not detectable.

The liquefaction process increases fuel quality by removing many gaseous impurities, such as CO₂, H₂S and water, that are commonly associated with pipeline gas. LNG also provides an opportunity for cogeneration by cooling various mechanical components enroute to the engine, where it arrives and is utilized in its gaseous form. The LNG liquefaction process and the facilities used therein are well known to those of ordinary skill in the art.

While it is well know that natural gas can power vehicles and can be used a refrigerant fluid, what is not known is a distribution system and method to commercialize the use of natural gas as a transport fuel and serendipitously use the natural gas as a climate control method for perishable products and a sales product for retail to the public. Particularly, food staffs and medical products must be transported in what is known as refrigeration trucks. Currently, these refrigeration trucks are also powered by fuels that are crude oil derivatives. The invention disclosed herein teaches a method to and system for distribution networks using liquid natural gas, LNG, wherein a variety of types of distribution nodes and transport vehicles are combined to form a distribution network that does not require crude oil derivative fuels. The distribution network may contain a variety of distribution nodes including LNG manufacturing plants, LNG storage facilities, LNG fueling facilities, LNG cooled warehouses, CNG fueling stations, and a fleet of vehicles that use natural gas as a fuel for the distribution systems vehicles, coolant for product containers attached to the vehicles and or within the distribution system network of warehouses and retail stores such that natural gas can be used and/or commercially sold at the stores for fuel and be used as coolants for refrigeration processes. This method then combines these nodes, natural gas powered vehicles, and natural gas cooling containers and warehouse into a distribution system that is not dependent on crude oil derivative products, while yielding a viable and environmentally superior distribution system.

In the preferred embodiment, there is a network for product distribution where LNG is made from natural gas at a plurality of points across the network. In this embodiment there are five basic types of points in the distribution network. The first point is where LNG is manufactured. The second point is where LNG is used to fuel vehicles in the system. The third type point is a point where LNG is used to cool refrigeration facilities. The fourth point is a retail sales point for LNG to be sold to the public as LNG or CNG. The fifth point is a place where LNG from an outside source is delivered to the network. This invention teaches the use of any combination of the five type of points at any point in the distribution network.

For example, at one location one may have a LNG manufacturing plant, LNG fueling station for network trucks, LNG container storage with LNG continually supplied to a fleet of containers on site, and no large refrigerated warehouse. Another point in the network may have an LNG plant and a storage tank for LNG and have network LNG transport trucks delivering LNG to outlying distribution points that do not have an LNG manufacturing plant. A still further combination is a retail store in the distribution network where over-the-road trucks powered by LNG or CNG arrive to deliver products and then refuel at the retail store's LNG fueling station where the public also purchase LNG or CNG fuel when they come to shop at the retail store. A still different combination is a point in the network system that has network LNG trucks fueling at a port where LNG is generated at a point outside the network and is then delivered to the network by the LNG transport trailers of the system. A still further point in the distribution system may be where the point has natural gas delivered from an underground reservoir, the LNG is manufactured at the point, the LNG is then used to cool a refrigerated warehouse, and supply an LNG or CNG fueling station for LNG or CNG powered vehicles and LNG or CNG cooled trailers and containers, supply LNG or CNG for the networks transport vehicles, and sell LNG or CNG for retail to other natural gas powered vehicles and natural gas transport companies. Sources of natural gas for the distribution network include natural gas wells or gas fields, oil fields where natural gas is associated with oil production, LNG terminals through which LNG is imported from overseas sources, as well as other sources known to those ordinary skill in the art.

The overall system may comprise a vast array of different combinations of distribution points. Preferably, the system comprises a variety of distributed LNG plants, storage, and sales points that are geographically located such that natural gas is always available to the networks distribution system using a variety of the systems LNG trucks, transports, containers, trailers, and LNG manufacturing plants. This embodiment then is a system of natural gas-powered vehicles, connecting distributed LNG manufacturing points throughout the system. The method also teaches using the natural gas fuel for refrigeration purposes and electrical generation purposes in appropriate distribution points.

LNG plants are connected to a source, which in the preferred embodiment the source is an underground reservoir and the LNG is manufactured and stored in cryogenic storage tanks. Filling stations for cryogenic natural gas or compressed natural gas are located at or near the LNG plant where over the road trucks can be fueled with natural gas. In the preferred embodiment, these over the road LNG or compressed natural gas trucks pull tractors with containers or refrigeration trailers that have LNG storage tanks. These LNG storage tanks on the trailers in the preferred embodiment are mounted on the top portion of the container or trailer and have heat exchanger coils to allow the heat to be drawn from the containers and trailers inside storage. At least a portion of this heated LNG from the container and trailer is then routed to the LNG truck engine for fuel. An auxiliary engine fueled by this heated LNG can also be attached to the container or trailer to run a refrigeration system for the container and trailer thereby allowing a container or trailer to be independently cooled by LNG and the refrigeration system.

The distribution nodes can be set up with the LNG from the storage and manufacturing plant to continually supply natural gas to a fleet of said containers to keep them cool thus reducing the cost of building larger refrigeration warehouses, and the energy losses when loading and unloading products. Hence in this method the goods distributed by natural gas containers and tractor trailers can be left at distribution nodes as distributed refrigerated mini-warehouses. Furthermore, the preferred embodiment would have the LNG manufactured at or near the systems warehouses cooling the warehouse facility with the natural gas. This is accomplished by having heat exchangers that use the cold LNG to take heat out of the air being circulated in the refrigerated warehouse or to use natural gas resulting from boiled off LNG from the system to power cooling or heating systems. Furthermore, some if not all distribution nodes for LNG can have storage warehouses that use electrical power generated by engineers powered with natural gas. Hence the distribution center and indeed the entire distribution network is capable of operating without electrical power or crude oil derivative fuels.

The LNG that is used in the distribution network can be sourced from outside the distribution network. For example, the source may be a natural gas pipeline. It may be an LNG pipeline from an LNG terminal supplied by an LNG transport ship. Alternatively, production of the LNG may be one aspect of the distribution network itself. For example, other sources of natural gas can be used, which are then converted into a liquefied state by compressing and cooling. Another example of an LNG source is an LNG storage tank. Also, the source may be an LNG manufacturing facility overseas from the distribution network.

The distribution network is also comprised of one or more warehouse facilities. The warehouse facilities are used to warehouse products, raw materials, and other goods at various points within the distribution network. The goods may be durable goods or perishable goods. The goods may be food or medical supplies. The warehouse facilities may require climate control depending upon their location and on the nature of the goods to be stored therein. As natural gas and LNG are good refrigerants, it can be used to cool the facilities where such cooling is required (e.g., to preserve perishable food or medical items) or it may be used to heat the facility in colder climates. As such, natural gas can fuel the transport of goods in the network, and well as facilitate transportation and storage by its ability to heat and cool.

The natural gas itself may be moved around in the network through any means known to those of ordinary skill in the art. This includes transport by pipeline, specialized cryogenic shipping containers, or by tanker truck. The distribution network should also comprise gaseous natural gas and LNG storage facilities to allow refueling, retail sales of natural gas, etc. These storage facilities may be above-ground or may be subterranean. In any part of the distribution system, the natural gas may exist as a gas or as LNG, however, for storage and transportation purposes, it is often preferable that the natural gas be in the form of LNG until it is actually used as either a fuel or a refrigerant.

The distribution network also comprises natural gas-fueled transportation units for the distribution of goods throughout the network. Although in the preferred embodiment, the natural gas fuels the prime mover of the over the road vehicles, it can also be used to power other systems, in addition to, or apart from, the primer mover. These are typically trucks, but other transportation units like ships, rail cars, and shipping containers, as well as other road vehicles may be used. The natural gas-fueled vehicles transport goods to and from different nodes in the distribution network and re-fuel with natural gas as needed at storage and re-fueling facilities. In some embodiments, the vehicle is a truck having a trailer cooled by liquid natural gas. In some embodiments, an over the road tractor pulls a separate but connected natural gas fuel trailer, behind a goods trailer forming a tandem trailer unit pulled behind the tractor. In a still further embodiment, the LNG is stored in tanks on the goods transport trailer as an integral part of the trailer unit. The truck and trailer move from one distribution center to another distribution center. The vehicle may drop the natural gas cooled trailer at the new distribution center, and attach a new trailer (either bearing a load or empty) to the vehicle, and then proceed to another distribution point in the network. The vehicle is fueled by natural gas and is optionally cooled by natural gas in the case of the transport of perishables. Likewise, a non-natural gas powered vehicle can be attached to a natural gas cooled trailer or container and wed to distribute the natural gas cooled trailer and goods within the network.

The network may also comprise one or more electrical generators which run on natural gas. Such generators can be coupled to an electrical transmission and/or distribution network. The electrical generators may be stand alone generators or they may be of an electrical generation facility comprising a plurality of electrical generators and electrical transmission equipment. Preferably, the electrical generators are coupled to a natural gas source in the network. The natural gas source may be a natural gas pipeline, an LNG transport vehicle or any other source capable of delivering natural gas to the electrical generator.

The fixed locations (warehouse facilities, LNG storage sites, LNG manufacturing plant, CNG fuel stations, etc.) in the distribution network are coupled to one another by the mobile elements of the distribution network (i.e., natural gas fueled trucks and other over-the-road vehicles). Additionally, the fixed locations may be coupled to one another by way of pipelines which may be above ground or which may be subterranean. Preferably, the distribution network should comprise as many LNG transport vehicles as possible in order that LNG may be supplied to any part of the distribution network that is in need of it at any given time.

The network described of the present invention could also be supplemented by additional elements that are energy-intensive and axe necessary to support commerce. This may include natural gas-powered hospitals, schools, private manufacturing facilities, government facilities, etc.

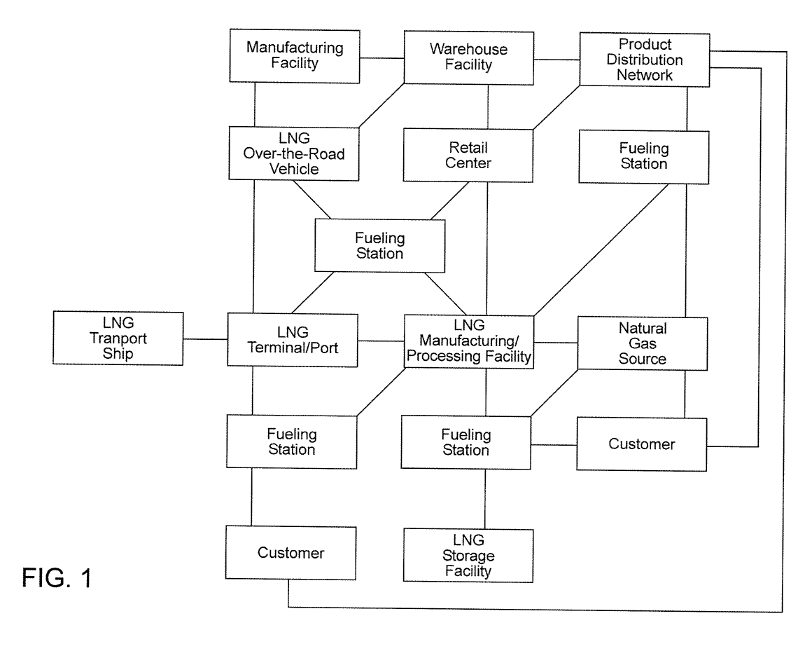

An illustrative example of the distribution network is shown in the schematic of FIG. 1. The schematic provides an illustrative examples of some of the elements of the natural gas network of the instant invention. The connections between the elements in the network can be any known to those of ordinary skill in the art. These include, but are not limited to roadways, waterways, railways, pipelines, etc. It should be noted that over-the-road vehicles include railroad transportation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for the distribution of goods and/or natural gas, said system comprising:
at least one source of natural gas;
optionally, at least one LNG plant coupled to said source;
at least one natural gas storage facility, said at least one storage facility coupled to said at least one source, said at least one LNG plant, or to any combination thereof;
a plurality of over the road vehicles powered by natural gas, said plurality of vehicles coupled to said at least one source of natural gas, to said at least one LNG plant, to said at least one natural gas storage facility, or to any combination thereof;
at least one retail facility, said at least one retail facility being a retail facility where products are sold and bought including natural gas, said at least one retail facility coupled to said at least one source, to said at least one LNG plant, to at least one of said plurality of over the road vehicles, or to any combination thereof; and,
at least one warehouse facility, said at least one warehouse facility coupled to said at least one source, to said at least one LNG plant, to at least one of said plurality of over the road vehicles, or to any combination thereof.

2. The system of claim 1, wherein the source is a natural gas pipeline.

3. The system of claim 1, wherein the source is a pipeline coupled to an LNG transport ship via an LNG terminal at a port.

4. The system of claim 1, wherein the source is an LNG storage tank.

5. The system of claim 1, wherein the source is an LNG transport trailer.

6. The system of claim 1, wherein the source is an LNG manufacturing facility overseas.

7. The system of claim 1, wherein the source comprises a natural gas well.

8. The system of claim 1, further comprising a network of distributed liquid natural gas plants.

9. The system of claim 1, wherein one or more of said plurality of over the road vehicles are cooled and/or heated by natural gas.

10. The system of claim 1, further comprising one or more electrical generators powered by natural gas.

11. The system of claim 10, wherein said generators are coupled to an electrical transmission and/or distribution network.

12. The system of claim 1, wherein at least one of said at least one LNG storage tank is located at a retail sales location.

13. The system of claim 1, wherein said plurality of over the road vehicles comprises at least one tractor-trailer, wherein said tractor-trailer has a prime mover that is powered by natural gas and further wherein said tractor-trailer is cooled and/or heated by natural gas.

14. The system of claim 1, wherein said at least one warehouse facility being cooled or heated by natural gas

15. A method of distributing goods and/or natural gas, said method comprising the step of:
coupling at least one source of natural gas with
optionally, at least one LNG plant coupled to said source;
at least one natural gas storage facility;
a plurality of over the toad vehicles powered by natural gas; and,
at least one warehouse facility.

16. The method of claim 15, wherein said step of coupling at least one source comprises coupling with a natural gas pipeline.

17. The method of claim 15, wherein said step of coupling at least one source comprises coupling with an LNG pipeline from a LNG transport ship.

18. The method of claim 15, wherein said step of coupling at least one source further comprises coupling with an LNG storage tank.

19. The method of claim 15, wherein said step of coupling at least one source further comprises coupling with an LNG manufacturing facility over seas from the distribution network.

20. The method of claim 15, wherein said step of coupling at least one source further comprises coupling with a network of distributed liquid natural gas plants.

21. The method of claim 15 wherein said wherein one or more of said plurality of over the road vehicles are cooled and/or heated by natural gas.

22. The method of claim 21 wherein said cooled or heated vehicles are cooled or heated by powered from a natural gas fueled fuel cell.

23. The method of claim 15, wherein said step of coupling at least one source fiber comprises coupling with one or more electrical generators powered by natural gas.

24. The method of claim 23, wherein the electrical generators comprise fuel cells powered by natural gas.

25. The method of claim 23, wherein said generators are coupled to an electrical transmission and/or distribution network.

26. The method of claim 15, wherein at least one of said at least one LNG storage tank is located at a retail sales location.

27. The method of claim 15, further comprising the step of pumping LNG as a liquid and heating said LNG to form a gas for compressed natural gas fuel applications.

28. The method of claim 27, wherein said natural gas fuel applications are selected from the group consisting of fuel cells, internal combustion engine, heating, cooking, and any combination thereof.

29. The method of claim 15, wherein said plurality of over the road vehicles comprises at least one tractor-trailer, wherein said tractor-trailer has a prime mover that is powered by natural gas.

30. The method of claim 15, wherein said plurality of over the road vehicles comprises at least one prime mover powered by a natural gas internal combustion engine.

31. The method of claim 15, wherein said plurality of over the road vehicles contains at least one fuel cell vehicle fueled with natural gas.

32. The method of claim 15, wherein said at least one warehouse facility is cooled and/or heated by natural gas.
